(19) United States
(12) Patent Application Publication
(10) Pub. No.: US 2015/0382063 A1
(43) Pub. Date: Dec. 31, 2015

(54) Processing Audio-Video Data to Produce Metadata

(71) Applicant: BRITISH BROADCASTING CORPORATION, London (GB)

(72) Inventor: Jana Eggink, London (GB)

(21) Appl. No.: 14/765,411

(22) PCT Filed: Feb. 5, 2014
(86) PCT No.: PCT/GB2014/050330

§ 371 Date: Aug. 3, 2015

(30) Foreign Application Priority Data
Feb. 5, 2013 (GB) 1301995.5

(51) Int. Cl. H04N 21/466; H04N 21/482; H04N 21/442; H04N 21/475; H04N 21/25; H04N 21/258

(52) U.S. Cl. CPC H04N 21/4668; H04N 21/252; H04N 21/25891; H04N 21/44222; H04N 21/4661; H04N 21/4667; H04N 21/4755; H04N 21/4756; H04N 21/4826

(57) ABSTRACT

A system for processing audio-video metadata for each of multiple portions of AV content to produce an output signal for an individual user, comprises an input for receiving multi-dimensional metadata having M dimensions for each of the portions of AV content and for receiving individual parameters for one or more of the M dimensions for the individual user. An input is arranged to receive general parameters for each of the M dimensions. A processor is arranged to determine a rating value for the individual for each portion of AV content as a function of the multi-dimensional metadata, the individual parameters and the general parameters to produce an output signal, wherein the function includes determining if a confidence value for each individual parameter is above a threshold and an output is arranged to assert the output signal.

### BACKGROUND OF THE INVENTION

This invention relates to a system and method for processing audio-video data to produce metadata.

Audio-video content, such as television programmes, comprises video frames and an accompanying sound track which may be stored in any of a wide variety of coding formats, such as MPEG-2. The audio and video data may be multiplexed and stored together or stored separately. In either case, a given television programme or portion of a television programme may be considered a set of audio-video data or content (AV content for short).

It is convenient to store metadata related to AV content to assist in the storage and retrieval of AV content from databases for use with guides such as electronic program guides (EPG). Such metadata may be represented graphically for user selection, or may be used by systems for processing the AV content. Example metadata includes the contents title, textural description and genre.

There can be problems in appropriately using metadata in relation to a given user. For example, a new user of a system may wish to extract certain information by searching metadata, but the nature of the result set should vary based on user parameters. In such circumstances, user parameters may not be available to inform the extraction process leading to poor results sets.

There can also be problems in the reliability of created metadata, particularly where the metadata requires some form of human intervention, rather than automated machine processing. If the metadata is not reliable, then the extraction process will again lead to poor results sets.

### SUMMARY OF THE INVENTION

We have appreciated the need to process metadata from audio-video content using techniques that appropriately take account user parameters.

In broad terms, the invention provides a system and method for processing metadata for AV content, in which the metadata comprises multiple dimensions, by weighting each dimension according to an individual parameter of a user or a default parameter in dependence upon a confidence value for each dimension, to produce an output signal. The processing may be undertaken for large volumes of AV content so as to assert an output signal for each set of AV content. Preferably, though, the outputs are further processed by ranking so as to provide a signal for all of the processed AV content.

In contrast to prior techniques, the present invention may process metadata that may be considered to have variable components along each of the M dimensions which can represent a variety of attributes. Such processing may be tailored, though, to take into account user parameters.

### BRIEF DESCRIPTION OF THE DRAWINGS

The invention will now be described in more detail by way of example with reference to the drawings, in which:

FIG. 1: is a diagram of the main functional components of a system embodying the invention;

FIG. 2: is a diagramatic representation of an algorithm embodying the invention;

FIG. 3: shows how user like/dislike ratings relate to moods based on memory;

FIG. 4: shows how user like/dislike ratings relate to moods based on experience; and

FIG. 5: shows results of an embodiment of the invention.

### DETAILED DESCRIPTION OF THE PREFERRED EMBODIMENTS

The invention may be embodied in a method and system for processing metadata related to audio-video data (which may also be referred to as AV content) to produce an output signal. The output signal may be used for controlling a display, initiating playback or controlling other hardware. The metadata is multi-dimensional in the sense that the metadata may have a value in each of M attributes and so may be represented on an M dimensional chart. Specifically, in the embodiment, the multi-dimensional metadata represents a “mood” of the AV content, such as happy/sad, exciting/calm or the like.

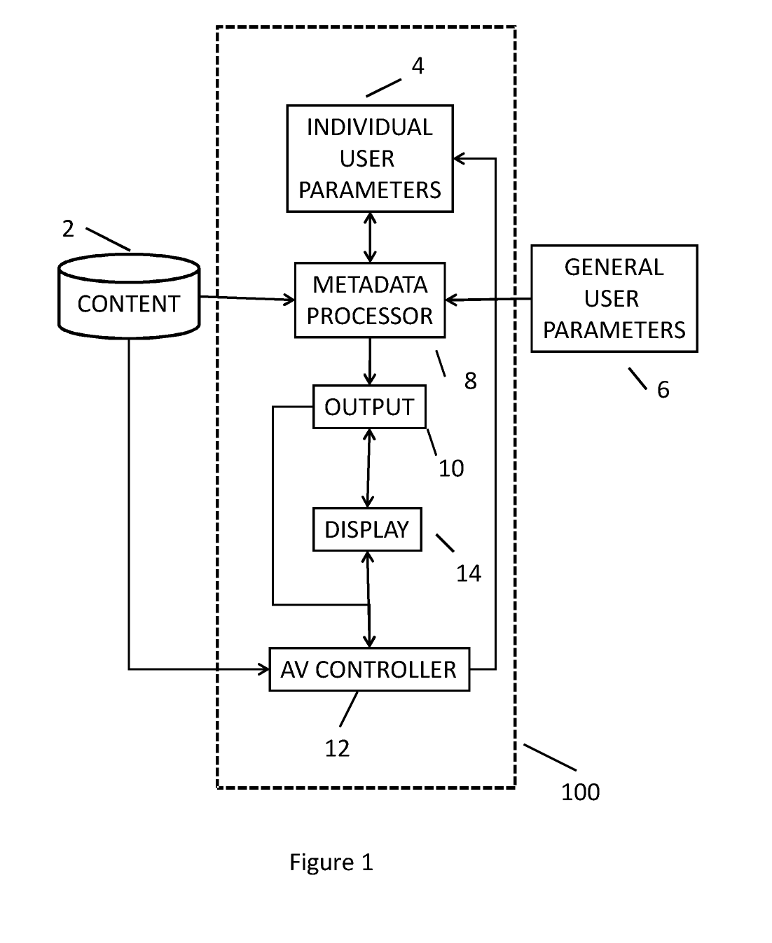

A system embodying the invention is shown in FIG. 1. The system may be implemented as dedicated hardware or as a process within a larger system. The system comprises a content store 2 that stores AV content and associated multi-dimensional metadata. For example, the AV content may comprise separate programmes each having metadata in the form of an M dimensional vector describing attributes such as mood, genre, pace, excitement and so on. A user may wish to query the content store to retrieve a programme of AV content and, for this purpose, a metadata processor is provided. The metadata processor has inputs from the content store (with metadata), general user parameters and individual user parameters related to the individual running the query. The individual user parameters 4 may be held against a user login, for example and may be updated each time the user retrieves content. The general user parameters 6 are parameters that generally apply to most users based on analysis for large populations of users. The steps undertaken by the metadata processor 8 will be described in more detail later.

An output 10 asserts an output signal as a result of the metadata processing. The output signal may control a display 14 to represent the output of the processing, for example by providing a list, graphical representation or other manner of presenting the results. Preferably, though, the output signal is asserted to an AV controller 12 that controls the retrieval of content from the store 12 to allow automated delivery of content to the display as a result of the user query.

The embodying system may be implemented in hardware in a number of ways. In a preferred embodiment, the content store 2 may be an online service such as cable television or Internet TV. Similarly, the general user parameters store 6 may be an online service provided as part of cable television delivery, periodically downloaded or provided once to the metadata processor and then retained by the processor. The remaining functionality may be implemented within a client device 100 such as a set top box, PC, TV or other client device for AV content.

In an alternative implementation, the client device 100 may include the content store 2 and the general user parameters store 6 so that the device can operate in a standalone mode to derive the output signal and optionally automatically retrieve AV content from the store 2.

A feedback line is provided from the AV controller 12 to the individual parameter store 4, by which feedback may be provided to improve the individual parameters, Each time a piece of AV content is received, the fact that the user likes or dislikes that content may be explicitly recorded (by user input) or implicitly recorded (by virtue of watching a portion or all of the selected programme). The values for dimensions associated with that programme may then be used to update the individual parameters, as described further later.

### Metadata Processor

The processing undertaken by the metadata processor 8 will now be described, followed by an explanation of possible uses and ways of improving the metadata itself.

Standard approaches to content-based data queries to produce query results such as recommendations typically build a model for each user based on available ratings. Techniques to do this include Support Vector Machines, k-nearest neighbour and, especially if ratings are on a scale and not just binary, regression. Such approaches provide limited success. Results from such approaches can be above baseline or random predictions, but personalisation is typically not successful. There is some general agreement between users about programmes they like or dislike; i.e. some programmes were liked or disliked by nearly all participants. Using the above mentioned standard techniques, modelling the general trend of like/dislike ratings is usually more successful than modelling individual users preferences.

The embodiment of the invention uses a new approach for metadata processing that may be used for mood based recommendation. Instead of building a single model that represents a user's preferences, each mood dimension is treated independently. This allows a processor to compute the influence of the different moods on user preferences for each user individually, e.g. one user might have a preference for serious programmes, but doesn't care if they are slow or fast paced, for another user this might be just the other way round. Traditional approaches include this information only indirectly, e.g. by incorporating the variance within one mood dimension into the model, the present approach makes this information explicit and allows direct manipulation. Especially when the knowledge about a user is limited, e.g. when he/she has just signed up for a service and only limited feedback had been obtained, the correlations between the mood dimensions and the user preferences will be week.

In most cases, some very general preferences exist that are true for the majority of users, e.g. in general users prefer fast-paced and humorous programmes, even if there will be individual users for whom this is not true. The system of this disclosure tests the correlation between existing user feedback (direct or indirect preferences, e.g. like/dislike ratings) and individual mood dimensions. Only for mood dimensions where the reliability of the correlation is above a set threshold, an individual preference model will be used. Other mood dimensions will not be ignored, but instead the general preference model will be used. This allows a system to gradually switch from making general recommendations to individual recommendations and has been shown to give better recommendations than traditional approaches. The approach is not limited to moods, other information like genre or production year can be integrated in the same way as the different mood dimensions. In general, the approach is applicable to M dimensional metadata for AV content.

For each user, individual user parameters are first derived by taking a correlation between “like” ratings provided by the user and the different mood dimensions. This may be based on the user specific training data, i.e. all rated programmes except the current one for which we are making a like/dislike prediction. The individual parameters may also be updated each time a user accesses AV content and provides direct feedback by indicating their preference, or indirectly by a proxy for preference such as how many times they watch the content and whether the entire content is viewed or merely a portion.

The mood values for the content are based on human assigned mood values, taking the average from all users, but excluding mood rates from the current user to maintain complete separation between training and test data. The correlation is computed using a correlation, here Spearman's Rank correlation, and in addition to the correlation coefficient a confidence measure is calculated, here a p-value, which gives the probability that the observed correlation is accidental (and statistically not significant). The smaller the p-value is, the higher is the probability that the observed correlation is significant.

The strength of the correlation between the “like” ratings and each mood dimension is used directly to determine the influence of that mood dimension. For example, assume that for one user the correlation between like ratings and happy is 0.4, and the correlation between like ratings and fast-paced is −0.2 based on the training data, indicating this user likes happy, slow-paced programmes. Then the happy value of the test AV content is multiplied with 0.4, and the fast-paced value with −0.2. The normalised sum of these is the predicted overall rating for the tested content for this user.

As an example, consider 2 dimensional metadata having dimensions: (i) happy and (ii) fast. A user may retrieve training data for 3 programmes, observe the content and provide an indication of their preference in the form of a “like” value on a scale of 1 to 5. This is shown in table 1.

TABLE 1

| Title | Happy | Fast | Like |
|---|---|---|---|
| Eastenders | 1 | 4 | 5 |
| Dr Who | 4 | 5 | 4 |
| Earthflight | 3 | 1 | 1 |

From this training information, the individual user parameters for each dimension can be derived using a correlation algorithm as described above. The results are shown in table 2.

TABLE 2

| | Individual Correlation | P value |
|---|---|---|
| Happy | −0.19 | 0.88 |
| Fast | 0.97 | 0.15 |

At this point, a predicted rating for any new content may be determined as R=−0.19*happy dimension+0.97*fast dimension

More generally,

R=ΣI₁*D₁+I₂*D₂

or

R=ΣₙIₙ*Dₙ

Where D is the dimension and I the individual parameter for that dimension for the given user.

We have appreciated, though, that the individual parameter for a given dimension may not always be reliable, for example if insufficient training data exists. In order to remove unreliable values, a general parameter value derived for general users may be used in place of an individual value for each dimension.

For example, we use the p-values of the correlations with each mood to determine if a user specific model should be used in each mood dimension. The lower negative correlation with fast-paced might have a high p-value, indicating that the observed correlation was most likely accidental and is not significant. In these cases, we do not use the user specific correlation between that particular mood dimension and the like ratings, but instead use the positive correlation of the general trend (i.e. a positive correlation between fast-paced and like, and not the user specific negative one).

The influence of the individual mood dimensions can be computed in different ways, using either the value (i.e. correlation strength) of the individual model, the general model or combination of both. The final rating prediction is based on a weighted sum of all mood dimensions, so increasing the influence of one mood automatically decreases the influence of the others. For this reason we choose to use the weight as indicated by the individual model, and change the sign of the correlation to that of the global model if the p-value is above 0.5 (i.e. the observed correlation is most likely accidental). If the correlation is accidental, but the sign of the correlation is the same for the individual and the global model, nothing is changed and the individual model is used.

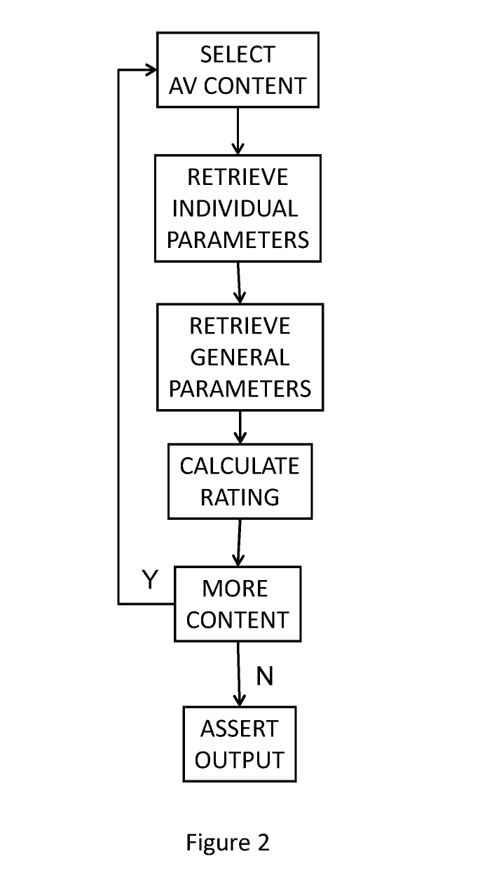

So, the algorithm compares the confidence value for a dimension for an individual against a threshold and, if the confidence value is above the threshold then the individual parameter is used, but with the sign of the value changed to match the sign of the general parameter for that dimension. A summary of the algorithm of this disclosure if shown in FIG. 2.

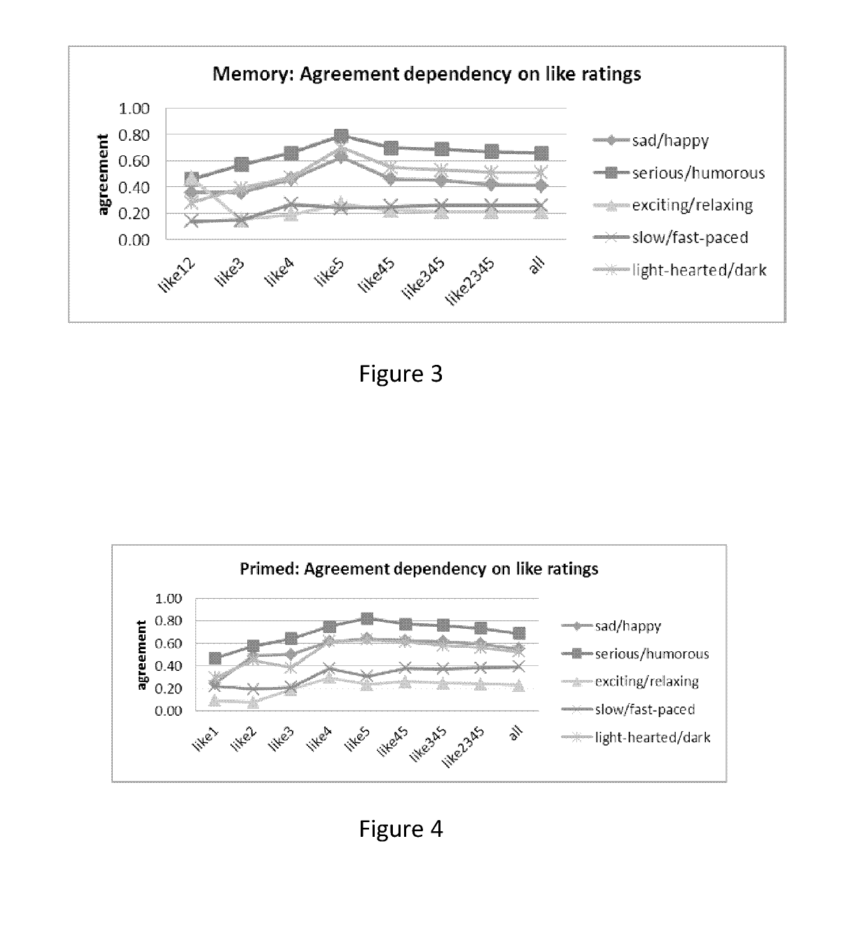

At a first step, AV content, such as a programme, is selected and the metadata retrieved. The metadata is multi dimensional. At a second step, the individual parameters relating to the user requesting data are retrieved. The individual parameter may be of the type set out in table 2 above, namely a value indicating the correlation and a value giving the likelihood of the correlation being correct for each dimension. At a next step, the general parameters are retrieved that result from analysis for many people of the correlation for each dimension and the selected AV content. The general parameters include a general correlation, an example of which is shown on FIG. 3.

At the next step, the rating for the AV content for that user is calculated according to a function that includes considering at least an individual parameter for each dimension and a general parameter for each dimension. At a next step, if more AV content is available, it is selected and the calculation above repeated for that content. The process is repeated until calculations are performed for all of the relevant content. An output is then asserted. The output may be a signal to retrieve the content that has been scored with the highest rating, or to retrieve multiple such portions of AV content, or to control a display to indicate some form of ranking.

TABLE 3

| | General Correlation |
|---|---|
| Happy | 0.40 |
| Fast | 0.79 |

The general correlation is shown in table 3. As can be seen, the individual correlation parameters of table 2 have a high P value (low confidence) for the “happy” dimension. Accordingly, the value of the correlation for that dimension is used, but the sign is changed to match the (in this case positive) sign of the general correlation. The ratings are therefore given by:

Newsnight R=0.19*1+0.97*1=1.16

Torchwood R=0.19*3+0.97*5=5.42

| | Happy | Fast | Rating |
|---|---|---|---|
| Newsnight | 1 | 1 | 1.16 |
| Torchwood | 3 | 5 | 5.42 |

As an alternative, where the confidence value indicates a low level of confidence for one of the parameters, the general value for that parameter may be used instead, the general value representing the value appropriate for most people.

We would then have:

R=ΣG₁*D₁+I₂*D₂ . . . .

Where G₁ is the general parameter for dimension 1 (here the “happy” dimension) and I₂ is the individual parameter for the given user for dimension 2 (here the “fast” dimension). This would give alternative values as follows.

Newsnight R=0.40*1+0.97*1=1.37

Torchwood R=0.40*3+0.97*5=6.05

As can been seen, swapping to use a general value instead of an individual value may impact the final rating given.

In an example use of the method, programmes were assigned values on 6 dimensions, here 6 mood scales, sad/happy, serious/humorous, exciting/relaxing, interesting/boring, slow/fast-paced and light-hearted/dark. Interesting/boring was very closely correlated with the like ratings of users, with little agreement between users and therefore excluded from the recommendation experiment. For the remaining moods, the overall correlation was tested between individual mood and like ratings. Slow/fast-paced showed the strongest correlation, followed by sad/happy, exciting/relaxing, and with very low correlations serious/humorous and light-hearted/dark.

The trial tested the recommendation system, increasing the number of moods used, starting with those with the highest correlation. Best results were achieved using the three moods with relatively high correlation, slow/fast-paced, sad/happy, exciting/relaxing. Adding either serious/humorous or light-hearted/dark did not improve results, so all subsequent experiments were based on using three moods dimensions.

To evaluate precision at three, i.e. the accuracy of the top three recommendations made for each user, we first established a baseline. We used the memory based ratings, and as expected users remembered more programmes they liked than those they disliked. Random guessing among the programmes remembered by each user gave a baseline of 71% accuracy. Using a global model, based on the general correlations between moods and like rating but without any adjustments for user specific preferences, improved accuracy to 75%, showing that there is some basic agreement between users about the type programme they like to watch. However, user specific models outperformed the global ones, giving 77% recommendation accuracy. Introducing our new method of combining the global and the user specific model gave a further increase to 78%.

### Improved Metadata

In the example use of the method, differences were noted in the user agreement about which moods were assigned to a programme. This depended to a noticeable extent on how much people liked a specific programme. There is no absolute truth about how happy, serious, or fast-paced a programme is, the only thing we can measure is how much people agree. We looked at various subgroups of users, and measured the agreement within such a group, and compared it with the agreement between all subjects.

In the example a strong relationship was noted between the amount people liked a programme, and the agreement of mood labels assigned by them. In general, people who liked a programme, agreed about the appropriate mood labels for it, while there was little agreement among people who didn't like it. This observation was true both for moods assigned based on the memory of a programme, and even when moods were assigned after the subjects watched a short excerpt, see FIGS. 3 and 4. We show agreement selecting only rates from one specific like rating, where a rating of 1 (like1) actually means he/she strongly disliked it, while a rating of 5 (like5) indicates that the user liked the programme very much. For the memory based condition we have few dislike ratings, and therefore joined like1 and like2, i.e. strong and medium dislike. It can be seen that the agreement tends to increase when mood rates associated with a higher like rating are chosen, reaching a peak at like5. Consecutively adding mood rates with lower like decreases the agreement. This behaviour is very clear for sad/happy, serious/humorous and light-hearted/dark, less so for slow/fast-paced and exciting/relaxing, which also show less user agreement overall.

The rating algorithm as described above uses the programme moods to develop a preference model for each user, and rates new programmes based their moods. In the example, we use manually assigned moods, taking the average of all available mood ratings. Next, we evaluated if we could improve the reliability of the mood tags by taking into account if the moods were assigned by a user who liked or disliked the programme. Instead of taking the direct average of all mood ratings, we introduced a weighted average scheme, giving more influence to the ratings of people who liked the programme. We found that a simple linear weighting worked well, using the like rating (on a scale from 1 for strong dislike to 5 for strong like) to weight the mood rating of that person for one particular programme.

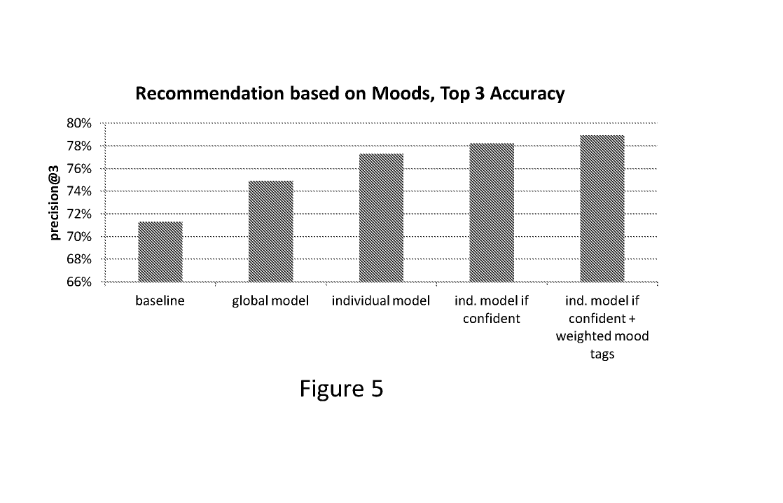

Using the same set up as described above, we only changed the way of how the mood tags for each programme were computed. This gave a further improvement, increasing the recommendation accuracy to 79%, the best result obtained on this dataset, for an overview of all results see FIG. 5.

The process described above may be implemented using a system as shown in FIG. 1, but instead of retrieving general user parameters from the store 6, parameters are determined by retrieving content, displaying to users, receiving assigned dimension values and like/dislike values and determining general dimension parameters as a result using the metadata processor to run a routine as follows.

First, a piece of content, such as a programme, is retrieved and presented to multiple users. Each user selects a value for each of multiple dimensions to describe the content. In addition, each users assigns a value to describe whether they liked/disliked the programme.

A general parameter for a given dimension G₁ may then be determined by a general equation of the form:

G₁=f(g₁ᵢ,I₁ᵢ)

Where G₁ is the general parameter for dimension 1, gᵢᵢ is the dimension assigned by user i and I₁ᵢ is like value assigned by user I and f is a function for all users.

More particularly, the general value for a dimension may be given by:

G₁=Σg₁ᵢ*I₁ᵢ

The like values I₁ᵢ may be on a chosen scale such as from 1 to 5, thereby providing a weighting to the dimension parameters.

A use case for automatically determining the general dimension parameters is in query engines in which users may select values for various mood dimensions and these are matched against previously derived dimension values for content. In such a system, the general dimensions may be continually updated by receiving feedback from viewers providing dimension ratings for content.

1. A system for processing audio-video metadata for each of multiple portions of AV content to produce an output signal for an individual user, comprising:
an input for receiving multi-dimensional metadata having M dimensions for each of the portions of AV content;
an input for receiving individual parameters for one or more of the M dimensions for the individual user;
an input for receiving general parameters for each of the M dimensions;
a processor arranged to determine a rating value for the individual for each portion of AV content as a function of the multi-dimensional metadata, the individual parameters and the general parameters to produce an output signal, wherein the function includes determining if a confidence value for each individual parameter is above a threshold; and
an output arranged to assert the output signal.

2. A system according to claim 1, wherein the function comprises summing the result of multiplying each dimension by the corresponding individual parameter or general parameter depending upon whether the confidence value for each individual parameter is above a threshold.

3. A system according to claim 2, wherein the function comprises multiplying each dimension by the corresponding individual parameter if the confidence value is above a threshold, and by the corresponding general parameter if the confidence value is below the threshold.

4. A system according to claim 2, wherein the function comprises multiplying each dimension by the corresponding individual parameter if the confidence value is above a threshold, and by the individual parameter adjusted to have the sign of the general parameter if the confidence value is below the threshold.

5. A system according to claim 1, wherein the confidence value for each dimension for each user is derived from training data from the user.

6. A system according to claim 5, wherein the training data comprises an indicator of whether the user likes/dislikes each of multiple portions of training AV content and previously assigned dimension parameters for the training AV content.

7. A system according to claim 6, wherein the confidence value for each dimension for each user is derived as a function of how well the like/dislike indicators and previously assigned dimension parameters are related.

8. A system according to claim 7, wherein the function comprises the correlation of the like/dislike indicators and previously assigned dimension parameters.

9. A system according to claim 1, wherein the output is arranged to control a display to produce a ranked list of portions of AV content.

10. A system according to claim 1, wherein the output is arranged to automatically retrieve or store AV content from or to the content store.

11. A system according to claim 1, comprising one of a set top box, television or other user device.

12. A system for deriving a general parameter for each of multiple dimensions for portions of AV content, comprising:
an input for receiving user assigned parameters for one or more dimensions of each portion of AV content;
an input for receiving a score for each portion of AV content indicating whether each user likes/dislikes that portion of AV content; and a metadata processor for deriving a general parameter for each dimension as a function of the user parameters and like/dislike indicators.

13. A system according to claim 12, wherein the function comprises weighting each user assigned parameter with the score indicating like/dislike for that user.

14. A system according to claim 12, wherein the function is according to the following equation G₁=Σg₁ᵢ*I₁ᵢ where G₁ is the general parameter for dimension 1, g₁ᵢ is the dimension assigned by user i and I₁ᵢ is like value assigned by user I.

15. A system according to claim 12, further comprising a search engine arranged to search for AV content using the general parameter assigned to each dimension.

16. A method of processing audio-video metadata for each of multiple portions of AV content to produce an output signal for an individual user, comprising:
receiving multi-dimensional metadata having M dimensions for each of the portions of AV content;
receiving individual parameters for one or more of the M dimensions for the individual user;
receiving general parameters for each of the M dimensions;
determining a rating value for the individual for each portion of AV content as a function of the multi-dimensional metadata, the individual parameters and the general parameters to produce an output signal, wherein the function includes determining if a confidence value for each individual parameter is above a threshold; and
asserting the output signal.

17. A method according to claim 16, wherein the function comprises summing the result of multiplying each dimension by the corresponding individual parameter or general parameter depending upon whether the confidence value for each individual parameter is above a threshold.

18. A system according to claim 17, wherein the function comprises multiplying each dimension by the corresponding individual parameter if the confidence value is above a threshold, and by the corresponding general parameter if the confidence value is below the threshold.

19. A method according to claim 17, wherein the function comprises multiplying each dimension by the corresponding individual parameter if the confidence value is above a threshold, and by the individual parameter adjusted to have the sign of the general parameter if the confidence value is below the threshold.

20. A method according to claim 16, wherein the confidence value for each dimension for each user is derived from training data from the user.

21. A method according to claim 20, wherein the training data comprises an indicator of whether the user likes/dislikes each of multiple portions of training AV content and previously assigned dimension parameters for the training AV content.

22. A method according to claim 21, wherein the confidence value for each dimension for each user is derived as a function of how well the like/dislike indicators and previously assigned dimension parameters are related.

23. A method according to claim 22, wherein the function comprises the correlation of the like/dislike indicators and previously assigned dimension parameters.

24. A method according to claim 16, wherein the method is arranged to control a display to produce a ranked list of portions of AV content.

25. A method according to claim 16, wherein the method is arranged to automatically retrieve or store AV content from or to the content store.

26. A method for deriving a general parameter for each of multiple dimensions for portions of AV content, comprising:
receiving user assigned parameters for one or more dimensions of each portion of AV content;
receiving a score for each portion of AV content indicating whether each user likes/dislikes that portion of AV content; and
deriving a general parameter for each dimension as a function of the user parameters and like/dislike indicators.

27. A method according to claim 26, wherein the function comprises weighting each user assigned parameter with the score indicating like/dislike for that user.

28. A method according to claim 26, wherein the function is according to the following equation G₁=Σg₁ᵢ*I₁ᵢ where G₁ is the general parameter for dimension 1, g₁ᵢ is the dimension assigned by user i and I₁ᵢ is like value assigned by user I.

29. A method according to claim 26, further comprising searching for AV content using the general parameter assigned to each dimension.
